(19) United States
(12) Patent Application Publication
(10) Pub. No.: US 2020/0139928 A1
(43) Pub. Date: May 7, 2020

(54) TIRE LOCK APPARATUS AND METHOD

(71) Applicant: The Tire Tag, LLC, Georgetown, TX (US)

(72) Inventor: Kenneth Coleman, Georgetown, TX (US)

(21) Appl. No.: 16/677,448

(22) Filed: Nov. 7, 2019

Related U.S. Application Data
(60) Provisional application No. 62/757,000, filed on Nov. 7, 2018.

(51) Int. Cl. B60R 25/09; G07C 9/00; G06K 9/00; G06Q 20/14

(52) U.S. Cl. CPC B60R 25/09; G06Q 20/14; G06K 9/00791; G07C 9/00309

(57) ABSTRACT

A method of citing a parking violation includes locating a removable locking device around a wheel of the vehicle. The locking device is located to permit the mobility of the vehicle but act as a nuisance when in motion. A driver is permitted to settle the infraction through multiple ways wherein the driver pays a fee for the infraction and a core fee for the locking device. The core fee may be refunded upon successful return of the locking device to a collection unit. The act of ticketing and securing the vehicle are done in a concurrent set of steps.

### CLAIM OF PRIORITY

This application claims the benefit of U.S. Provisional Application No. 62/757,000, filed 7 Nov. 2019. The information contained therein is hereby incorporated by reference.

### BACKGROUND

### 1. Field of the Invention

The present application relates to a locking device, and in particular, to an apparatus for the locking or tagging of a vehicular tire along with the method of using the locking device to enforce parking violations.

### 2. Description of Related Art

Vehicles provide a great deal of portability for society and come in different shapes and sizes. There exists laws or regulations which control the use of vehicles. Some of these laws deal with places, times, and the manner of parking a vehicle. Where a vehicle is parked in violation with the laws or policies of a location, it may be cited by an authorized public safety officer. Customarily a public safety officer drafts up a ticket and leaves notice on the vehicle windshield or driver window of the ticket, whereby the ticket requires a fine to be paid. These tickets often go unpaid for long periods of time and can be forgotten by the driver.

In some instances, a parking violation may necessitate or warrant immobilizing the vehicle in a manner that prevents movement of the vehicle. These detaining devices may be locks applied around the wheel of a vehicle. The idea of these locks (i.e. boot) is to prevent the vehicle from moving. By restricting mobility of the vehicle, the intent is to ensure payment of the fine. Typically, these detaining devices wrap partially around the wheel and tire such that it extends across the tread to both sides of the wheel. The tire is prevented from rotating. The locks may couple to the wheel about the center hub area and typically extend outward from the wheel and tire with a protrusion designed to damage the vehicle if the tire rotates. A disadvantage of these locks is that the vehicle is essentially completely disabled. It is becoming increasingly desired that such immobilization is frowned upon in case of emergency situations. Emergency situations may arise that would necessitate movement of the vehicle despite the violation but which end up being hindered to do so from use of a traditional lock.

Although great strides have been made with respect to vehicle locks and methods of citing a violation, considerable shortcomings remain. A locking apparatus is needed that provides a deterrent to moving the vehicle but does not operate to fully incapacitate the vehicle.

### SUMMARY OF THE INVENTION

It is an object of the locking device and method of the present application to simplify the method of citing a parking violation while ensuring prompt payment of the fine without having to immobilize a vehicle. A locking device is used to act as a physical deterrent to a driver to avoid driving the vehicle but is operated and attached to the vehicle so as to not fully immobilize the vehicle. The locking device attaches to the rim of a vehicle only and does not wrap around the tire. The locking device is configured to limit the speed at which the vehicle is able to drive comfortably.

The method of citing a parking violation includes capturing the vehicular data electronically through an electronic device and installing the locking device to the rim of the wheel. A notice may be placed on a window for detection by the driver. Upon detection, the driver may visit a website and identify the vehicle. Payment may be made wherein a code is sent to the driver to allow the locking device to be removed. The driver then returns the locking device within a collection unit. This method encourages swift payment of the violation without fully immobilizing the vehicle.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a chart of a method of tagging a vehicle according to an embodiment of the present application.

FIG. 2 is a flowchart depicting operational steps of an electronic device incorporating software for use in the method of tagging a vehicle of FIG. 1.

FIG. 3 is a side view of the vehicle in the method of tagging a vehicle of FIG. 1.

FIG. 4 is an enlarged side view of a tire of the vehicle of FIG. 3.

FIG. 5 is a front view of a locking device used in the method of tagging a vehicle of FIG. 1.

FIG. 6 is a collection unit used in the method of tagging a vehicle of FIG. 1.

FIG. 7 are exemplary steps to perform the method of tagging a vehicle of FIG. 1.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method in accordance with the present application overcomes one or more of the above-discussed problems commonly associated with the prior art discussed previously. In particular, the method of citing a parking violation includes locating a physical deterrent onto the vehicle in a manner that deters movement of the vehicle without immobilizing the vehicle in case of emergency. The locking device is located around a rim/wheel but avoids wrapping around the tire. The wheel assembly is permitted to rotate. A driver may pay the citation electronically and receive a code to remove the locking device. The driver may then return the locking device to a collection unit and be reimbursed for the locking device. These and other unique features are discussed below and illustrated in the accompanying drawings.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The embodiments and method of the present application is illustrated in the associated drawings. The features and functions are illustrated and discussed below.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

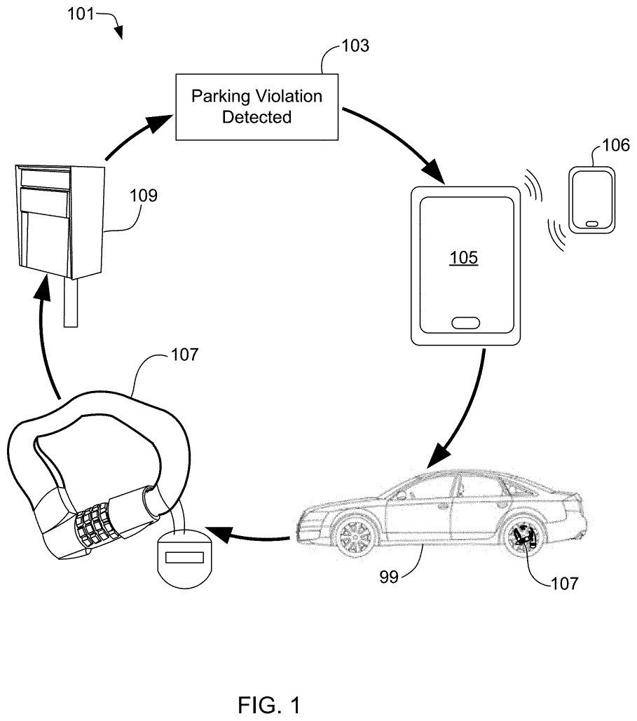

Referring now to FIG. 1 in the drawings, a chart of a method of tagging a vehicle is shown. Chart 101 illustrates some components and steps involved with the methods as used. The method used and described in the present application is configured to provide increased resolution of vehicular violations while maintaining vehicular mobility in case of emergencies. As seen in FIG. 1, a public safety office may identify a vehicular violation/infraction 103. The public officer uses an electronic device 105 to capture vehicular information for the issuance of a ticket or warning. The vehicular information is captured electronically and may be configured to communicate wirelessly to one or more remote devices. The public safety officer places a locking device 107 on the vehicle 99 in a manner that permits mobility or driving of the vehicle without damage. A notice is provided to the driver of the vehicle of the infraction and the locking device 107. Upon detection by the driver, the driver may gather the information off the notice and/or the locking device 107 to settle or pay the fine. Upon doing so, the driver may be informed of a code or identifier used to remove locking device 107 from the vehicle 99. Optionally the user may elect to place locking device 107 into a collection unit 109. Doing so will permit a reimbursement of a portion of the fee paid to settle or pay the fine.

It is understood that FIG. 1 provides a high level view of the general steps and elements within the method of the present application. Of note is that locking device 107 may be optionally used without an official public safety officer (i.e. police officer) but may be used by staff of various establishments, security guards and the like to enforce valid rules at a particular location. Other examples of potential users may include companies, municipalities or organizations that want to enforce parking area violations through a simple, efficient and effective solution. Other examples may include: Security companies, Municipalities, Hospitals, Convention Centers, Universities, Private Shopping Centers/Malls, Government facilities, Police/Military, HOAs, subdivisions, apartment complexes, as well as Theme parks, Zoos, and Amusement Parks.

Furthermore, the actual step of issuing a citation is not required. The method may be reduced to merely locating the locking device 107 on a vehicle, thereby bypassing electronic device 105.

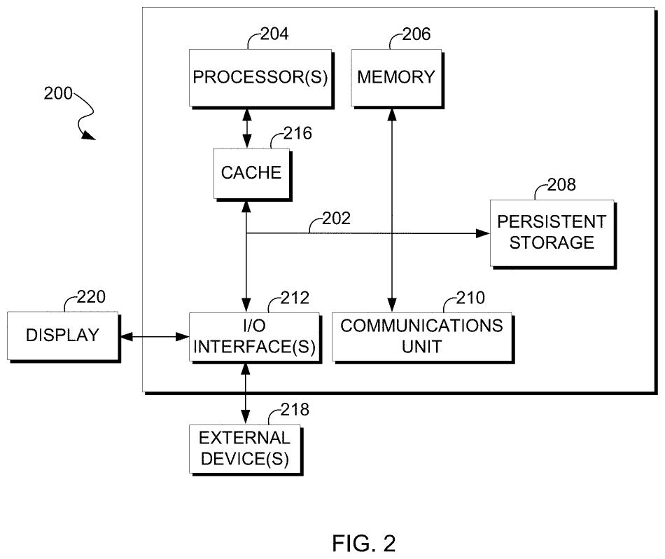

Referring now also to FIG. 2 in the drawings, a flowchart depicting steps and components of electronic device 105 are illustrated. It is understood that the description associated with FIG. 2 may be equally applicable to any other electronic device used with the present method of FIG. 1. For example, personal electronic device 106 may be used by a driver to send and receive data for the settling of the infraction and pay the fine.

FIG. 2 depicts a block diagram of exemplary components of computing systems that may interact within the method of FIG. 1. It should be appreciated that FIG. 2 provides only an illustration of one implementation and does not imply any limitations with regard to the environments in which different embodiments can be implemented. Many modifications to the depicted environment can be made.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Computer system 200 includes communications fabric 202, which provides communications between cache 216, memory 206, persistent storage 208, communications unit 210, and input/output (I/O) interface(s) 212. Communications fabric 202 can be implemented with any architecture designed for passing data and/or control information between processors (such as microprocessors, communications and network processors, etc.), system memory, peripheral devices, and any other hardware components within a system. For example, communications fabric 202 can be implemented with one or more buses or a crossbar switch.

Memory 206 and persistent storage 208 are computer readable storage media. In this embodiment, memory 206 includes random access memory (RAM). In general, memory 206 can include any suitable volatile or non-volatile computer readable storage media. Cache 216 is a fast memory that enhances the performance of computer processor(s) 204 by holding recently accessed data, and data near accessed data, from memory 206.

Software programs used to permit the collection of vehicle information and transacting settlement may be stored in persistent storage 208 and in memory 206 for execution by one or more of the respective computer processors 204 via cache 216. In an embodiment, persistent storage 208 includes a magnetic hard disk drive. Alternatively, or in addition to a magnetic hard disk drive, persistent storage 208 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 208 may also be removable. For example, a removable hard drive may be used for persistent storage 208. Other examples include optical and magnetic disks, thumb drives, and smart cards that are inserted into a drive for transfer onto another computer readable storage medium that is also part of persistent storage 408.

Communications unit 210, in these examples, provides for communications with other data processing systems or devices. In these examples, communications unit 210 includes one or more network interface cards. Communications unit 210 may provide communications through the use of either or both physical and wireless communications links. The software may be downloaded to persistent storage 208 through communications unit 210.

I/O interface(s) 212 allows for input and output of data with other devices that may be connected to device 105 and or device 106. For example, I/O interface 212 may provide a connection to external devices 218 such as a keyboard, keypad, a touch screen, and/or some other suitable input device. External devices 218 can also include portable computer readable storage media such as, for example, thumb drives, portable optical or magnetic disks, and memory cards. Software and data used to practice embodiments of the present invention, e.g., the software and associated data and files, can be stored on such portable computer readable storage media and can be loaded onto persistent storage 208 via I/O interface(s) 212. I/O interface(s) 212 also connect to a display 220.

Display 220 provides a mechanism to display data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Electronic device 105 and personal electronic device 106 may take many different shapes or forms. They may be a personal handheld computer, a smart phone, or the like. They are configured to transfer and receive image data from pictures taken and or keystroke data such as typed characters. A driver may use device 106 to access and settle the fine or make payment by communicating with device 105 or other remote computer having similar software. It is recognized that a driver may use a phone to settle the account verbally as well.

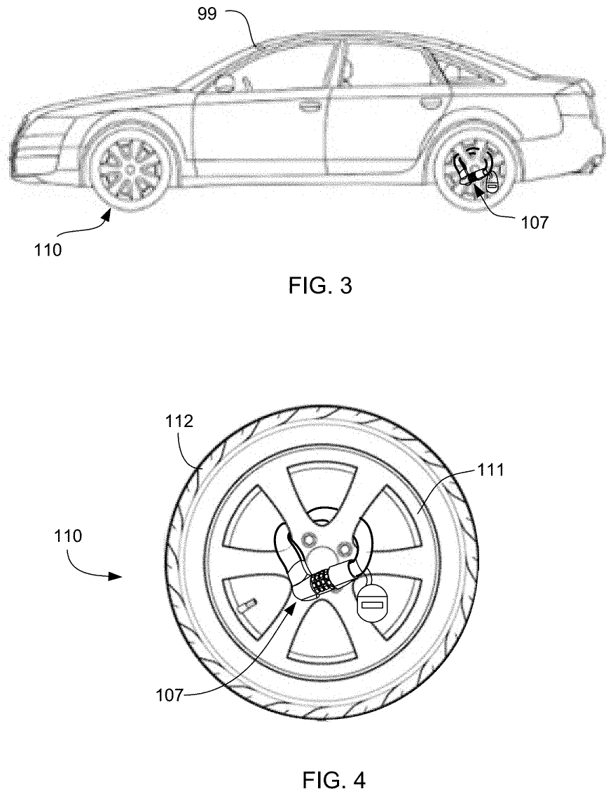

Referring now also to FIG. 3-5 in the drawings, a side view of vehicle 99 is shown with locking device 107 installed together with an enlarged side view of a wheel assembly 110 of vehicle 99. Device 107 is located on the wheel assembly 110 such that locking device 107 is passed around portions of rim 111. Device 107 is not passed around tire 112. In fact, device 107 avoids contact with tire 112, so as to enable or maintain the mobility of vehicle 99. Upon driving with locking device 107, the car will experience vibrations causing a nuisance to the driver but not limit the ability of the car to drive. It is important to remember that device 107 may be located on any of the wheel assemblies of a vehicle but it is preferred that it be with the rear wheel assemblies to avoid potential steering issues at higher speeds.

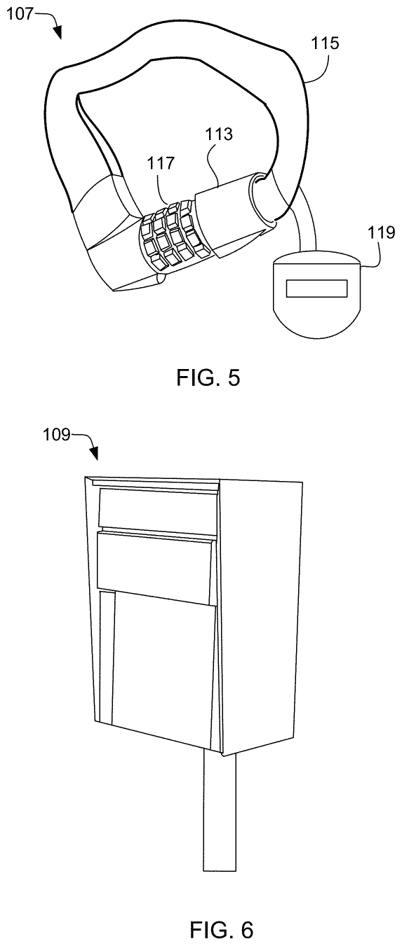

In FIG. 5 a front view of locking device 107 is shown. Device 107 includes a main body that houses an attachment device 113. A strap 115 extends out of attachment device 113 at opposing ends so as to form a loop when fully closed. Strap 115 is selectively detachable along one end. Attachment device 113 is configured to operate between a closed and open orientation. In the closed orientation (as shown), strap 115 is secured relative to the main body. In the open orientation (not shown), at least one end of strap 115 is released as attachment device 113 translates to the open orientation thereby providing for the release of one end of strap 115. When open, strap 115 may be routed through one or more portions of rim 111.

Control of attachment device 113 is regulated through interface 117. Interface 117 may a combination locking interface of any type, electronic interface, mechanical interface, include one or more dials, and so forth. Ideally it is of the type that provides for a user to enter a code, sequence of numbers or digits, or any pictorial images. As keys cannot be transferred easily it is preferred that keyed interfaces are not used. Information related to codes, numbers, and images are more easily transmitted over long distances. For example, devices 105 and 106 are ideally suited for transferring information to allow the driver to selectively unlock device 107.

Movement of attachment device 113 provides for the release and/or capture of the ends of strap 115. As a locking device, it is necessary that the composition of strap 115 is of such material that it is not easy for a driver to cut through it. Strap 115 may be composed of a braided wire with loops at either end. These loops engage attachment device 113. A sheath may also be included around the braided wire to prevent rust or moisture issues on the wire. It is understood that many materials may be used in place of a metallic wire.

A tag 119 may be included with locking device 107 to display a unique identifier of the locking device 107. This identifier is used by the driver to identify which vehicle is his or hers. The identifier may be entered via device 106 and the software can match the driver to the particular vehicle for payment and settlement of the account. It is understood that the identifier may be located physically on attachment member 113 or strap 115 thereby negating the need of tag 119.

Referring now also to FIG. 6 in the drawings, a perspective view of a collection unit 109 is provided. Unit 109 is configured to be a collection point for locking device 107 after it have been removed from a vehicle. The driver, after settling the account, is given the ability to remove locking device 107. The user is then able to drop it off at unit 109 for reuse with another driver should the need arise. Unit 109 is depicted as a rigid solid structure. Unit 109 is configured to secure one or more devices 107 and prevent its theft and is not herein limited to the depicted form as shown.

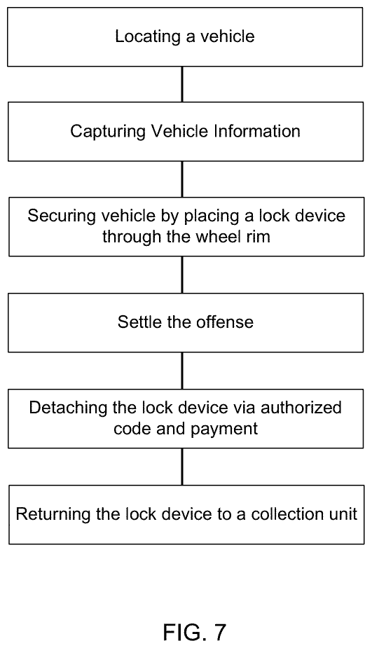

Referring now also to FIG. 7 in the drawings, steps to perform the method of tagging a vehicle so as to enforce a vehicular violation is provided. By following these steps, a vehicle will be tagged with a nuisance device that permits mobility of the car in case of emergencies but dutifully encourages the driver to remove it as soon as possible, thereby encouraging the settlement of any fines or fees.

In the method of the present application, a vehicle is identified that may be violating a law. For example this could include parking illegally or in general be in violation of posted parking policies/laws for the given parking area. Once the infraction is identified, a user is able to capture the vehicle information through an electronic device 105. Pictures of the vehicle at the scene may be taken and stored. Identifying information of the vehicle may be typed into device 105 and stored locally or in a remote computer.

The locking device is then attached to a wheel assembly of the vehicle in a manner that permits mobility of the vehicle (i.e. the ability to drive). Once attached, it is locked via a combination lock or other styled lock. The vehicle being tagged is also ticketed for the violation in the same step and must pay a ticket amount, plus a deposit for the cost of the locking device to receive a code for to remove the locking device themselves.

It is conceived that a user, upon detection of identifying a vehicle violation will desire to settle the account and resolve the issue prior to proceeding to drive. The user may coordinate payment through different ways, such as using a personal electronic device 106 to communicate through a network like the internet, call a phone number, or may use a locally installed machine on site to act as a payment portal. A user notes the identifier of the locking device installed on the vehicle and inputs that into the system software to match the driver with the vehicle. Details of the offense or violation are provided and the driver may elect to settle the account by paying the infraction costs. If payment is made, the driver is provided a code to remove the locking device.

To encourage the driver to return the locking device, a core fee may be applied to the account prior to payment or settlement. The core fee is an additional refundable fee used to encourage the driver to return the locking device. Once returned into an authorized collection unit, the core fee will be refunded to the driver. If the driver elects to not return the locking device, the core fee will not be refunded. The collection unit is ideally located on the premises in an accessible and visible location.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A method of citing a parking violation, comprising:
identifying a vehicle violation;
capturing the vehicle information;
locating a locking device on a rim of a wheel assembly of the vehicle in a manner that permits mobility of the vehicle;
coordinating settlement of the vehicle violation; and
removing the locking device.

2. The method of claim 1, wherein the vehicle violation is a parking violation.

3. The method of claim 1, wherein the locking device is located around the rim of the vehicle without contacting the tire.

4. The method of claim 3, wherein the locking device permits rotation of the wheel assembly.

5. The method of claim 3, wherein the locking device is coupled only to the rim of the wheel assembly.

6. The method of claim 1, wherein the vehicle information is captured via an electronic device configured to capture images and keystroke data.

7. The method of claim 6, wherein the electronic device is configured to communicate with a portable electronic device of a driver of the vehicle electronically.

8. The method of claim 1, wherein the vehicle is tagged with the locking device and ticketed concurrently.

9. The method of claim 1, wherein the locking device is assigned a unique identifier, the identifier being input into an electronic device by the driver for associating a vehicle with the driver while coordinating settlement.

10. The method of claim 9, further comprising:
transmitting a code associated with the locking device, the code being used to remove the locking device from the vehicle once payment is made.

11. The method of claim 10, further comprising: returning the locking device to a collection unit.

12. The method of claim 11, further comprising: receiving a refund of a portion of a fee paid after returning the locking device to the collection unit.

13. The method of claim 1, further comprising:
receiving payment for the vehicle violation.

14. The method of claim 13, wherein payment includes a refundable core fee for the locking device.

15. The method of claim 14, wherein the refundable core fee is refunded upon return of the locking device to a collection unit.

16. The method of claim 13, further comprising:
returning the locking device to a collection unit.
